(19) United States
(12) Patent Application Publication
(10) Pub. No.: US 2017/0303096 A1
(43) Pub. Date: Oct. 19, 2017

(54) TERMINAL DEVICE AND COMMUNICATION METHOD

(71) Applicant: FUJITSU LIMITED, Kawasaki-shi (JP)

(72) Inventors: Katsuyuki Masuda, Yokohama (JP); Yuki Shinada, Saitama (JP); Yasuo Tezuka, Yamato (JP); Yutaka Hamada, Yokosuka (JP); Hiromitsu Kawai, Yokohama (JP); Takahiro Kawaguchi, kamakura (JP); Hiroaki Maruyama, Sagamihara (JP)

(73) Assignee: FUJITSU LIMITED, Kawasaki-shi (JP)

(21) Appl. No.: 15/479,911

(22) Filed: Apr. 5, 2017

(30) Foreign Application Priority Data
Apr. 14, 2016 (JP) 2016-081350

(51) Int. Cl. H04W 4/08; H04W 76/02; H04W 28/18; H04W 4/00; H04W 8/22

(52) U.S. Cl. CPC H04W 4/08; H04W 76/021; H04W 28/18; H04W 8/22; H04W 4/005

(57) ABSTRACT

A communication method executed by a terminal device included in a plurality of terminal devices, the communication method comprising obtain first identification information used in a group including the plurality of terminal devices and state information, the first identification information being used for device identification in communication between a base station and each of the plurality of terminal devices, the state information indicating whether the first identification information is allocated to the terminal device or not, and when it is determined that the first identification information is not allocated to the terminal device based on the state information, requesting a usage right of the first identification information for the plurality of terminal devices in response to obtaining data to be transmitted to the base station, and transmitting the data to the base station using the first identification information after obtaining the usage right.

### CROSS-REFERENCE TO RELATED APPLICATION

This application is based upon and claims the benefit of priority of the prior Japanese Patent Application No. 2016-081350, filed on Apr. 14, 2016, the entire contents of which are incorporated herein by reference.

### FIELD

The embodiments discussed herein are related to a terminal device and a communication method.

### BACKGROUND

Machine to machine (M2M) modules have been introduced into various systems of vending machines for drinking water and cigarettes, management of distribution and operation of buses and taxis, and the like. Further, because reductions in size, weight, and power consumption of M2M modules have recently become possible, M2M modules are used in a wider variety of applications. For example, M2M modules have been used for reading electricity, gas, and water meters and also used as hand-held terminals and payment terminals. In addition, with the progress of radio access network technology, the speed of communications and the volume of information transmitted and received in the communications have been increased. It is therefore expected that M2M modules transmitting and receiving larger amounts of data than heretofore will increase in the future.

FIG. 1 is a diagram of assistance in explaining an example of communication processing using M2M modules. FIG. 1 illustrates an example of processing in a case where M2M modules (terminals 5a to 5c) communicate via a base station 10. In a case C1, each of the terminals 5a to 5c performs communication by separately coupling to the base station 10. However, in a system in which each individual terminal 5 couples to the base station 10 as illustrated in the case C1, as the number of terminals 5 included in the system increases, communication information managed by the base station 10 is increased, and thus a load imposed on the base station 10 is increased.

Accordingly, a system is proposed in which, as illustrated in a case C2, one of the plurality of terminals 5 communicates with the base station 10 as a representative of the other terminals 5. In the example of FIG. 1, the terminal 5a communicates with the base station 10 as a representative of the terminals 5a to 5c. In this case, data obtained in the terminal 5b and the terminal 5c is transmitted to the base station 10 via the terminal 5a.

As related technologies, a method is proposed in which an M2M terminal in an M2M terminal group determines an access resource according to an identifier of the group, and makes network access as a representative of the group using the determined access resource (for example, Japanese National Publication of International Patent Application No. 2014-517585). Another method is proposed in which, when performing network reentry, an M2M terminal in an idle mode obtains information related to selection of an M2M group representative, and uses the obtained information (for example, Japanese National Publication of International Patent Application No. 2014-524711). A method is also proposed in which a group of terminals storing different extension numbers on subscriber identity module (SIM) cards use a common international mobile subscriber identifier and a common mobile station integrated services digital network (ISDN) number (Japanese National Publication of International Patent Application No. 2008-515267, and the like).

### SUMMARY

According to an aspect of the embodiments, a terminal device included in a plurality of terminal devices, the terminal device including a memory and a processor coupled to the memory and the processor configured to obtain first identification information used in a group including the plurality of terminal devices and state information, the first identification information being used for device identification in communication between a base station and each of the plurality of terminal devices, the first identification information being allocated to any one of the plurality of terminal devices at a certain timing, the state information indicating whether the first identification information is allocated to the terminal device or not, when it is determined that the first identification information is not allocated to the terminal device based on the state information, request a usage right of the first identification information for the plurality of terminal devices in response to obtaining data to be transmitted to the base station, and transmit the data to the base station using the first identification information after obtaining the usage right.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of assistance in explaining an example of communication processing using M2M modules;

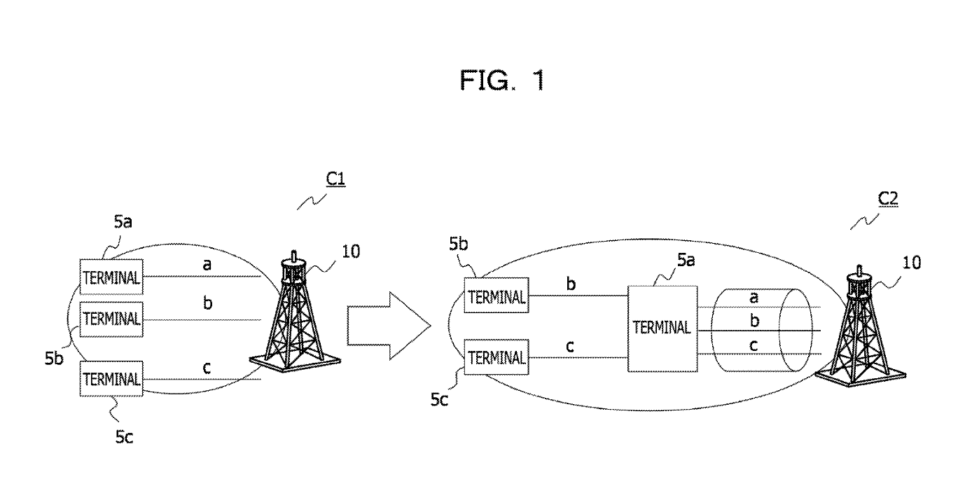

FIG. 2 is a diagram of assistance in explaining an example of a communication method according to an embodiment;

FIG. 3 is a diagram of assistance in explaining an example of configuration of a terminal device;

FIG. 4 is a diagram of assistance in explaining an example of hardware configuration of a terminal device;

FIG. 5 is a sequence diagram of assistance in explaining an example of processing of a terminal device forming a group;

FIG. 6 is a diagram of assistance in explaining an example of neighboring group search processing;

FIG. 7 is a diagram of assistance in explaining an example of a group accommodation table;

FIG. 8 is a diagram of assistance in explaining an example of processing in response to a joining request;

FIG. 9 is a sequence diagram of assistance in explaining an example of processing at a time of joining a group;

FIG. 10 is a diagram of assistance in explaining an example of message formats;

FIG. 11 is a sequence diagram of assistance in explaining an example of processing at a time of joining a group;

FIG. 12 is a sequence diagram of assistance in explaining an example of processing of changing a terminal device that performs communication;

FIG. 13 is a diagram of assistance in explaining an example of message formats;

FIG. 14 is a diagram of assistance in explaining an example of processing of transmitting data to a base station;

FIG. 15 is a sequence diagram of assistance in explaining an example of processing of receiving data from a base station;

FIG. 16 is a diagram of assistance in explaining an example of processing of updating a selection condition table and an example of the selection condition table;

FIG. 17 is a diagram of assistance in explaining an example of a method of determining a terminal device that is to perform waiting processing;

FIG. 18 is a diagram of assistance in explaining an example of message formats;

FIG. 19 is a diagram of assistance in explaining an example of message formats;

FIG. 20 is a diagram of assistance in explaining an example of processing at a time of withdrawal from a group;

FIG. 21 is a diagram of assistance in explaining an example of processing at a time of withdrawal from a group;

FIG. 22 is a diagram of assistance in explaining an example of messages used in a second embodiment; and

FIG. 23 is a sequence diagram of assistance in explaining an example of communication processing.

### DESCRIPTION OF EMBODIMENTS

In the case where the representative terminal integrates information obtained from the other terminals and communicates with the base station, the representative terminal transmits the information of the plurality of terminals to the base station. Therefore, a load imposed on the representative terminal is increased as compared with processing loads on the other terminals, and a processing delay due to the load on the representative terminal causes a communication delay. However, when the individual terminals separately communicate with the base station, a load on the base station is increased.

As one aspect, it is an object of the present embodiment to reduce a load on a base station without burdening a particular terminal.

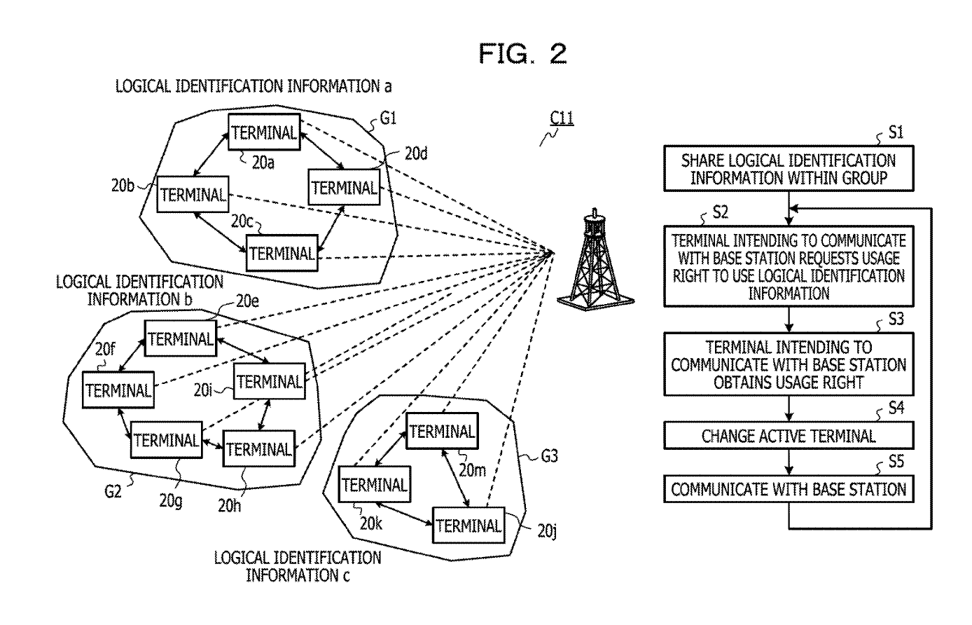

FIG. 2 is a diagram of assistance in explaining an example of a communication method according to an embodiment. In the example of FIG. 2, a base station 10 and a plurality of terminal devices 20 (20a to 20m) communicate with each other. In the communication method according to the embodiment, each of the plurality of terminal devices 20 forms a group with other terminal devices 20 located in the vicinity of the terminal device 20 according to respective positions of the terminal devices 20. Here, suppose that a terminal device located in the “vicinity” of a certain terminal device is a terminal device located within a range in which the terminal device may receive a message transmitted from the certain terminal device. In the example of a case C11, groups G1 to G3 are formed. The terminal devices 20a to 20d belong to the group G1. The terminal devices 20e to 20i belong to the group G2. Further, the terminal device 20j, the terminal device 20k, and the terminal device 20m belong to the group G3. Incidentally, in the following figures, “terminal device” may be entered as “terminal” for ease of viewing of the figures.

In each of the groups G1 to G3, identification information used in communicating with the base station 10 is shared between the terminal devices 20 belonging to the group, and a given number of terminal devices 20 use the identification information. Because identification information is shared within the groups, the base station 10 treats each group as a given number of logical terminal devices. Suppose in the example of FIG. 2 that the given number is one in order to simplify description. For example, the base station 10 treats each group as one logical terminal device. Further, in the following description, identification information shared within a group for communication with the base station 10 may be described as “logical identification information.” Suppose for example that the logical identification information in the group G1 is a. In addition, similarly, suppose that logical identification information=b is used in the group G2, and suppose that logical identification information=c is used in the group G3.

An example of processing performed in communication of terminal devices 20 belonging to a group will next be described with reference to a flowchart of FIG. 2. In step S1, a terminal device 20 communicates with the other terminal devices 20 belonging to the same group, and thereby obtains logical identification information and state information of the terminal devices 20 within the group. Here, suppose that the state information of the terminal devices 20 within the group indicates whether the individual terminal devices 20 belonging to the group have a usage right to use the logical identification information. Suppose for example that in the group G1, the terminal device 20a has the usage right to use the logical identification information=a. In this case, by communication between the terminal devices 20 belonging to the group G1, each of the terminal devices 20b to 20d recognizes the logical identification information=a and recognizes that the terminal device 20a has the usage right to use the logical identification information=a. In the following, a terminal device 20 having a usage right to use logical identification information may be described as an “active” terminal device 20, and terminal devices 20 not having the usage right to use the logical identification information may be described as “standby” terminal devices 20.

When a terminal device 20 in a standby state intends to start communicating with the base station 10, the terminal device 20 in the standby state requests the usage right to use the logical identification information from the active terminal device 20 and the other terminal devices 20 within the group (step S2). As a result of a setting change in each of the terminal devices 20 within the group or the like, the terminal device 20 intending to start communication with the base station 10 obtains the usage right to use the logical identification information (step S3). For example, when the terminal device 20b starts communicating with the base station 10, the terminal device 20b requests the usage right to use the logical identification information=a from the terminal device 20a in an active state and the terminal device 20c and the terminal device 20d in a standby state. When each of the terminal devices 20 makes a setting that gives the usage right to use the logical identification information=a to the terminal device 20b in response to the request from the terminal device 20b, the terminal device 20b may obtain the usage right.

After the processing of step S3 is ended, the active terminal device 20 is changed, and the newly active terminal device 20 communicates with the base station 10 (steps S4 and S5). For example, after the terminal device 20b changes a setting thereof to an active state, the terminal device 20b starts communicating with the base station 10 using the logical identification information=a. Here, the logical identification information used by the terminal device 20b to communicate with the base station 10 is the same as the logical identification information previously used by the terminal device 20a to communicate with the base station 10. The base station 10 therefore treats the terminal device 20b and the terminal device 20a as in a case where the terminal device 20b and the terminal device 20a are an identical mobile terminal device.

Communication processing similar to that of the group G1 is performed also in the other groups. Here, the method according to the embodiment sets only a given number of usage rights enabling usage of logical identification information within a group, and dynamically allocates the usage rights to terminal devices 20 intending to perform communication. For example, the number of couplings to the base station 10 in each group is equal to or less than the number of usage rights to use the logical identification information. It therefore suffices for the base station 10 to manage, as coupling destinations, information about terminal devices 20 whose number is equal to or less than the number of usage rights to use the logical identification information set for each group. Hence, the use of the method according to the embodiment reduces a processing load on the base station 10 as compared with a case where individual terminal devices 20 communicate with the base station 10. Further, in the method according to the embodiment, each individual terminal device 20 intending to communicate with the base station 10 obtains the usage right to use the logical identification information, and thereafter communicates with the base station 10. This avoids concentration of loads on a particular terminal device as in the case where the particular terminal device communicates with the base station on behalf of the other terminal devices.

<Device Configuration>

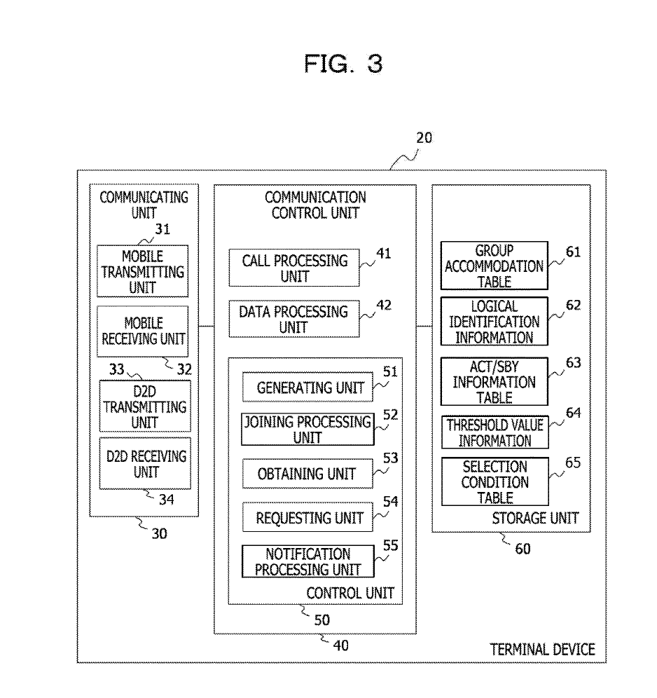

FIG. 3 is a diagram of assistance in explaining an example of configuration of a terminal device. The terminal device illustrated in FIG. 3 may be the terminal device 20 illustrated in FIG. 2. The terminal device 20 includes a communicating unit 30, a communication control unit 40, and a storage unit 60. The communicating unit 30 includes a mobile transmitting unit 31, a mobile receiving unit 32, a device to device (D2D) transmitting unit 33, and a D2D receiving unit 34. The communication control unit 40 includes a call processing unit 41, a data processing unit 42, and a control unit 50. The control unit 50 includes a generating unit 51, a joining processing unit 52, an obtaining unit 53, a requesting unit 54, and a notification processing unit 55. The storage unit 60 stores a group accommodation table 61, logical identification information 62, an ACT/SBY information table 63, threshold value information 64, and a selection condition table 65.

Information about terminal devices 20 accommodated in a group that the terminal device 20 has joined is recorded in the group accommodation table 61. The logical identification information 62 is logical identification information shared in the group that the terminal device 20 has joined. The ACT/SBY information table 63 is information indicating whether each of terminal devices 20 within the group is set in an active state or in a standby state. For example, the ACT/SBY information table 63 is state information indicating which of the terminal devices 20 within the group has the usage right to use the logical identification information 62. The ACT/SBY information table 63 may also be said to be state information used by each of the terminal devices 20 to determine whether the usage right to use the logical identification information 62 is assigned to the terminal device 20 itself. The threshold value information 64 is used to determine whether to allow a new terminal device 20 to join. The selection condition table 65 is used to determine a terminal device 20 that is to perform waiting processing when none of the terminal devices 20 in the group retains data to be transmitted.

The mobile transmitting unit 31 and the mobile receiving unit 32 are used for communication between the terminal device 20 and the base station 10. The D2D transmitting unit 33 and the D2D receiving unit 34 are used for communication between terminal devices 20. Here, a technology used for processing of the D2D transmitting unit 33 and the D2D receiving unit 34 is an arbitrary D2D technology including wireless fidelity (WiFi), Bluetooth (registered trademark), or the like. The call processing unit 41 performs call processing in communication using the mobile transmitting unit 31 and the mobile receiving unit 32. The data processing unit 42 processes data transmitted to and received between the terminal device 20 and the base station 10.

The generating unit 51 generates a part of information used as the logical identification information 62. The joining processing unit 52 performs processing for the terminal device 20 to join a group. Incidentally, depending on the position of the terminal device 20 or the like, there may be no group that the terminal device 20 may join in the vicinity of the terminal device 20. In this case, the joining processing unit 52 performs processing of forming a new group. When the terminal device 20 joins a group, the obtaining unit 53 obtains information to be stored as the logical identification information 62, the ACT/SBY information table 63, the threshold value information 64, and the selection condition table 65 from another terminal device 20 in the group. The requesting unit 54 generates a message for requesting another terminal device 20 in the group to set the own device active in order to perform communication with the base station 10. The notification processing unit 55 performs processing for notifying information retained by the own device to another terminal device 20.

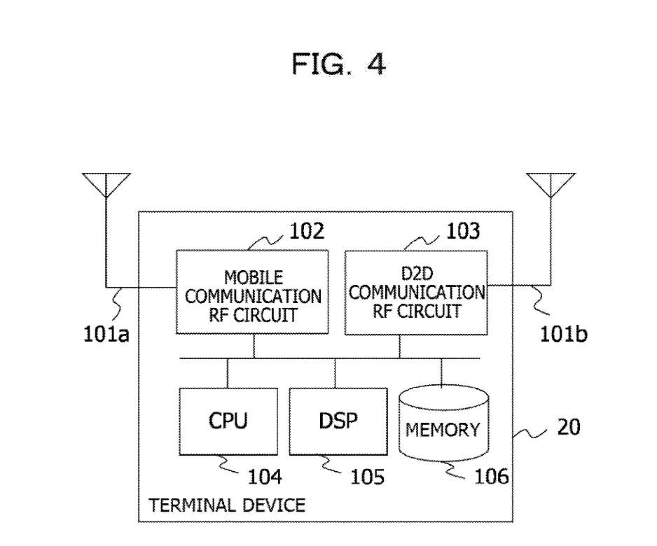

FIG. 4 is a diagram of assistance in explaining an example of hardware configuration of a terminal device. The terminal device illustrated in FIG. 4 may be the terminal device 20 illustrated in FIG. 2. The terminal device 20 includes an antenna 101 (101a and 101b), a mobile communication radio frequency (RF) circuit 102, a D2D communication RF circuit 103, a central processing unit (CPU) 104, a digital signal processor (DSP) 105, and a memory 106. The memory 106 includes a random access memory (RAM) and a read only memory (ROM). The CPU 104 and the DSP 105 may execute a program using the memory 106 as a work area. Incidentally, the memory 106 also stores the program processed by the CPU 104 and the DSP 105, data to be processed by the CPU 104 and the DSP 105, and the like. The mobile communication RF circuit 102, the D2D communication RF circuit 103, the CPU 104, the DSP 105, and the memory 106 are coupled to each other so as to be able to input and output data mutually. Incidentally, FIG. 4 is an example, and the CPU 104 and the DSP 105, for example, may be replaced with other arbitrary processors. In addition, the number of processors provided to the terminal device 20 is also arbitrary.

In the terminal device 20, the mobile transmitting unit 31 and the mobile receiving unit 32 are implemented by the mobile communication RF circuit 102. The D2D communication RF circuit 103 operates as the D2D transmitting unit 33 and the D2D receiving unit 34. The CPU 104 and the DSP 105 operate as the communication control unit 40. The memory 106 operates as the storage unit 60.

### First Embodiment

A first embodiment will be described in the following in divided sections on joining of a group by the terminal device 20, processing for communication with the base station 10, selecting a terminal device 20 to perform waiting processing, and withdrawal from the group. In the following description, in order to facilitate understanding of which terminal device 20 performs processing, the same alphabetic character as an end of a reference character of the terminal device 20 that performs the processing may be added to an end of a reference numeral. For example, a joining processing unit 52a is the joining processing unit 52 in the terminal device 20a.

(1) Joining Group

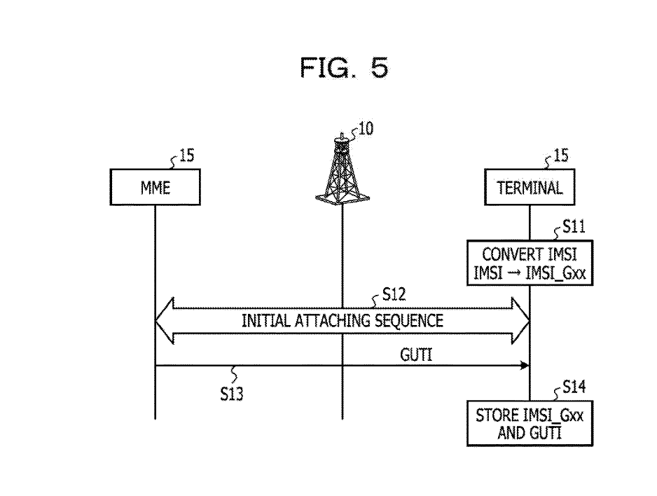

FIG. 5 is a sequence diagram of assistance in explaining an example of processing of a terminal device forming a group. The terminal device illustrated by reference to FIG. 5 may be the terminal device 20 illustrated in FIG. 2. Suppose that the terminal device 20a does not join already existing groups for a reason that there is no group in the vicinity of the terminal device 20a or the like. Then, the generating unit 51a in the terminal device 20a generates an international mobile subscriber identity (IMSI) to be used for group communication processing, by using an IMSI assigned to the terminal device 20a (step S11). Suppose in FIG. 5 that the terminal device 20a generates IMSI_Gxx to be used for communication in a group to which the terminal device 20a belongs. Incidentally, suppose that the generating unit 51a stores given arithmetic processing as a method of generating an IMSI in advance.

Thereafter, the call processing unit 41a in the terminal device 20a establishes connection with the base station 10 via the mobile transmitting unit 31a and the mobile receiving unit 32a as appropriate. The call processing unit 41a establishes coupling with the base station 10, and performs an initial attaching sequence between the call processing unit 41a and a mobility management entity (MME) 15 (step S12). Incidentally, in the initial attaching sequence, the call processing unit 41a notifies the MME 15 of IMSI_Gxx to be used for communication in the group. Therefore, position registration using the IMSI of the group including the terminal device 20a is performed in a home subscriber server (HSS). Incidentally, suppose that the MME 15 and the HSS recognize a range of possible values of IMSIs used for communication in groups, or recognize a method of calculating an IMSI for a group in a terminal device 20. Therefore, authentication processing in the MME 15 succeeds even when the MME 15 is notified of IMSI_Gxx to be shared in the group or the like.

At a time of setting of a bearer to be used for communication of the terminal device 20a from the MME 15, a globally unique temporary identifier (GUTI) is notified from the MME 15 to the terminal device 20a (step S13). The call processing unit 41a obtains a message including the GUTI via the mobile receiving unit 32a. The call processing unit 41a stores IMSI_Gxx generated by the generating unit 51a and the GUTI obtained in step S13 in the storage unit 60a (step S14). Incidentally, IMSI_Gxx generated by the generating unit 51a is stored as logical identification information 62a. As a result of these pieces of processing, the group accommodating the terminal device 20a is generated. The joining processing unit 52a in the terminal device 20a therefore records information about the terminal device 20a in the group accommodation table 61a.

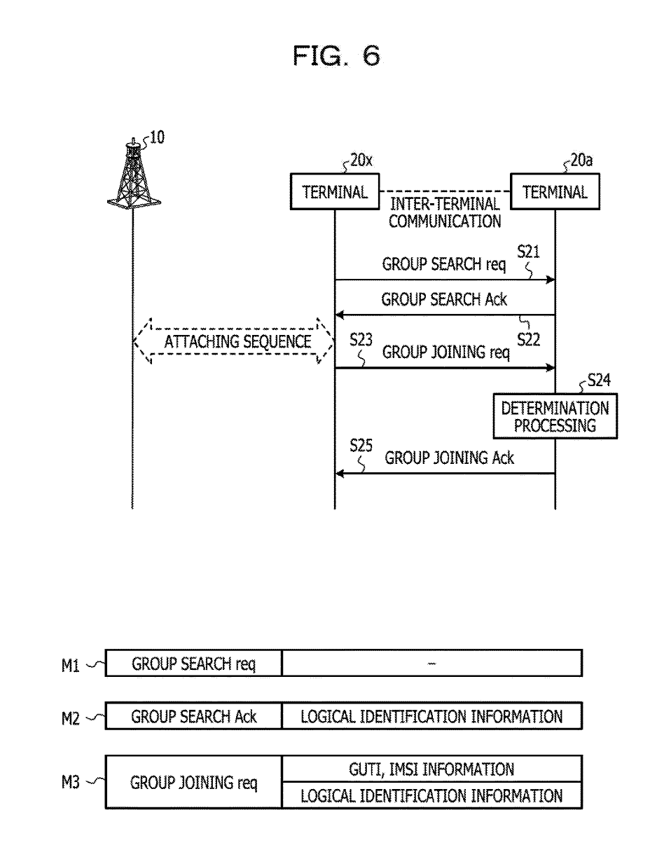

FIG. 6 is a diagram of assistance in explaining an example of neighboring group search processing. Suppose for example that a terminal device 20x not belonging to any group has moved to the vicinity of the terminal device 20a. In order to join the neighboring group, the joining processing unit 52x in the terminal device 20x generates a group search request, and transmits the group search request via the D2D transmitting unit 33x (step S21). M1 is an example of a message format of the group search request. As long as the group search request includes information indicating that the kind of the message is the group search request, the group search request does not need to include other information, or may include other information.

The D2D receiving unit 34a in the terminal device 20a receives the group search request, and outputs the received group search request to the joining processing unit 52a. The joining processing unit 52a generates a group search Ack, and transmits the group search Ack via the D2D transmitting unit 33a (step S22). M2 is an example of a message format of the group search Ack. The group search Ack includes information indicating the kind of the message and the logical identification information. In the example of FIG. 6, the IMSI (IMSI_Gxx) stored as the logical identification information 62a by the terminal device 20a is used as the logical identification information.

The joining processing unit 52x in the terminal device 20x obtains the group search Ack via the D2D receiving unit 34x. The joining processing unit 52x determines that there is a group in the vicinity because the group search Ack may be received. The joining processing unit 52x thus generates a message requesting to join the group (group joining request). M3 is an example of a message format of the group joining request. The group joining request includes an IMSI and a GUTI assigned to the transmission source of the group joining request and the logical identification information used in the group that the transmission source of the group joining request requests to join. In the example of FIG. 6, the group joining request includes the IMSI of the terminal device 20x, the GUTI obtained by the terminal device 20x in communication processing in the past, and the logical identification information notified in the group search Ack. The terminal device 20x transmits the group joining request to the terminal device 20a (step S23).

Incidentally, in a case where the terminal device 20x may join the group, the terminal device 20x may communicate using the logical identification information of the group that the terminal device 20x joins without performing an attaching sequence between the terminal device 20x and the base station 10. Therefore, as illustrated in FIG. 6, the terminal device 20x does not perform an attaching sequence between the terminal device 20x and the base station 10 while requesting to join the group located in the vicinity.

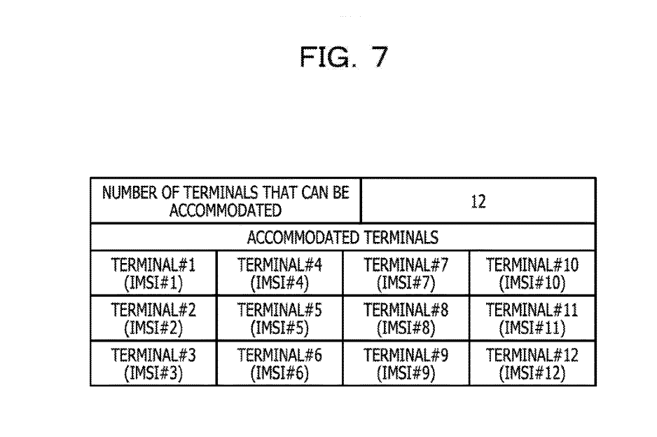

When obtaining the group joining request, the joining processing unit 52a in the terminal device 20a determines, using the logical identification information in the group joining request, whether the group joining request is a request to join the group to which the terminal device 20a belongs. When determining that the group joining request is a request to join the group to which the terminal device 20a belongs, the joining processing unit 52a determines, using the group accommodation table 61a, whether the terminal device 20x is allowed to join the group to which the terminal device 20a belongs (step S24). The joining processing unit 52a generates a message (group joining Ack) including a result of the determination, and transmits the message to the terminal device 20x via the D2D transmitting unit 33a (step S25). Details of processing in step S24 and step S25 will be described with reference to FIGS. 7 to 9 and the like.

FIG. 7 is a diagram of assistance in explaining an example of a group accommodation table. The group accommodation table illustrated in FIG. 7 may be the group accommodation table 61 illustrated in FIG. 3. The group accommodation table 61 includes the number of terminal devices 20 that are able to be accommodated in the group and information about terminal devices 20 currently accommodated in the group. In the example of FIG. 7, the number of terminal devices 20 that are able to be accommodated in the group is 12. The terminal devices 20 that have joined the group are assigned accommodated terminal numbers used for processing within the group. In the example of FIG. 7, the terminal devices 20 assigned respective accommodated terminal numbers of terminals #1 to #12 have already joined the group. IMSIs assigned to the respective terminal devices 20 are recorded in combination with the accommodated terminal numbers in the group accommodation table 61. Incidentally, the IMSIs are registered using the group joining requests (M3 in FIG. 6) transmitted at times of requests to join the group.

In a case where terminal devices 20 substantially equal in number to the number of terminal devices 20 that are able to be accommodated are accommodated as illustrated in FIG. 7, the joining processing unit 52 of the terminal device 20 that has received the group joining request determines that the transmission source of the group joining request is not allowed to join the group. In a case where the number of terminal devices 20 accommodated in the group is smaller than the number that is able to be accommodated, on the other hand, the joining processing unit 52 compares present traffic with a threshold value stored in advance in order to determine whether the transmission source of the group joining request may be allowed to join the group.

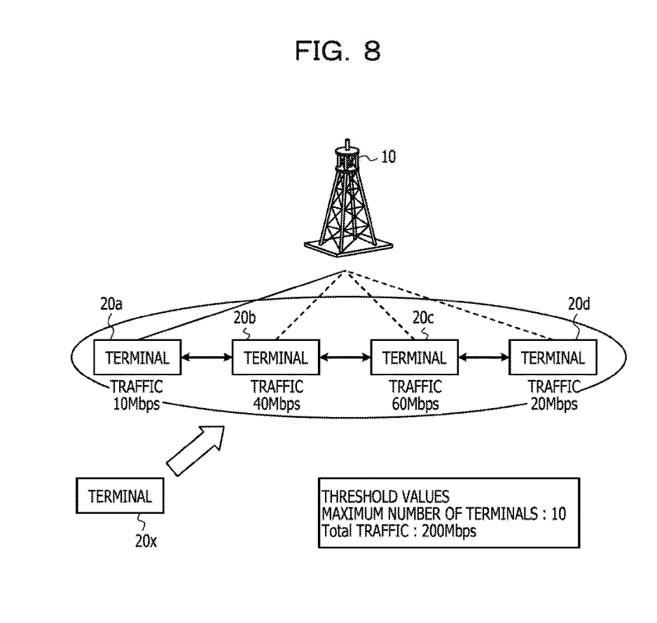

FIG. 8 is a diagram of assistance in explaining an example of processing performed when a group joining request is received. Suppose in the example of FIG. 8 that the number of terminals that are able to be accommodated in a group G1 is 10, while four terminal devices 20, for example, terminals 20a to 20d have joined the group G1. Further, suppose that a group joining request is transmitted from the terminal device 20x to the terminal device 20a. In this case, using the information in the group accommodation table 61a, the joining processing unit 52a in the terminal device 20a determines that there is a possibility of allowing the terminal device 20x to join the group G1 because the number of terminals in the group has not reached the upper limit.

The joining processing unit 52a refers to the threshold value information 64a. Recorded as the threshold value information 64a is information for determining whether or not to allow a new terminal device 20 to join the group, such as an upper limit value of traffic or the like which upper limit value is used to determine that a new terminal device 20 is allowed to join. Further, by communicating with the other terminal devices 20 within the group, the joining processing unit 52a may obtain information about traffic or the like of each terminal device 20 that has joined the group.

Suppose in the example of FIG. 8 that an upper limit threshold value of traffic for the group as a whole, which upper limit threshold value is used to determine that a new terminal device 20 is allowed to join, is recorded as the threshold value information 64a. In addition, suppose that the upper limit threshold value is 200 Mbps. In this case, when the traffic of the devices participating in the group is less than 200 Mbps, a new terminal device 20 is allowed to join. Further, suppose that the traffic of the terminal device 20a is 10 Mbps, that the traffic of the terminal device 20b is 40 Mbps, that the traffic of the terminal device 20c is 60 Mbps, and that the traffic of the terminal device 20d is 20 Mbps. Then, a total value of the traffic of the terminal devices 20a to 20d is 10 Mbps+40 Mbps+60 Mbps+20 Mbps=130 Mbps. Accordingly, the joining processing unit 52a determines that the terminal device 20x is allowed to join the group G1.

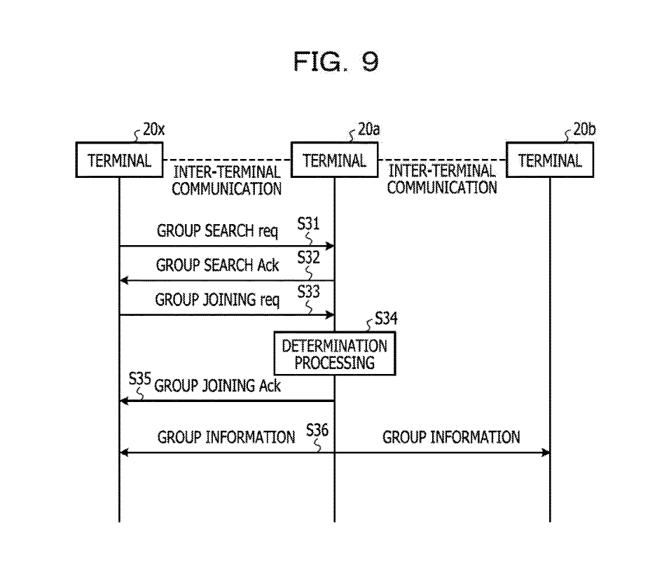

FIG. 9 is a sequence diagram of assistance in explaining an example of processing at a time of joining a group. Referring to FIG. 9, description will be made of processing performed when the terminal device 20x joins the group including the terminal devices 20a to 20d. Incidentally, in the sequence of FIG. 9, the terminal device 20c and the terminal device 20d are omitted.

In steps S31 to S33, the terminal device 20x is requesting the terminal device 20a to allow the terminal device 20x to join the group G1. Processing performed in steps S31 to S33 is similar to the processing of steps S21 to S23 described with reference to FIG. 6. Determination processing performed in step S34 is similar to the processing described with reference to FIG. 7 and FIG. 8.

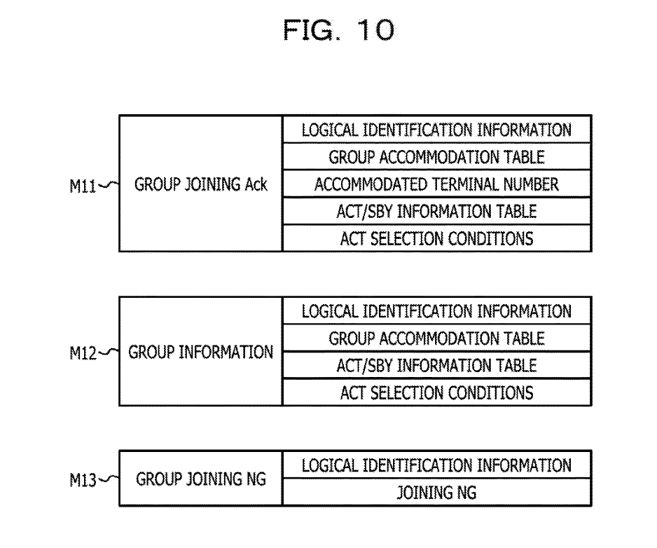

Suppose that the joining processing unit 52a determines in the determination processing of step S34 that the terminal device 20x may be allowed to join the group. Then, the joining processing unit 52a generates a group joining Ack addressed to the terminal device 20x and including information indicating a permission to join the group. Incidentally, a list of the terminal devices 20 participating in the group may be used as information indicating the permission to join the group. The terminal device 20 allowed to join determines that the terminal device 20 is allowed to join when the list notified in the group joining Ack includes the identification information of the terminal device 20. The following description will be made by taking as an example a case where the list of the terminal devices 20 in the group G1 (group accommodation table 61) is used as information indicating the permission to join the group G1. An example of information elements in the group joining Ack including the permission to join the group will be described with reference to FIG. 10. The terminal device 20a transmits the group joining Ack to the terminal device 20x (step S35).

The joining processing unit 52x in the terminal device 20x determines whether the message received via the D2D receiving unit 34x includes the logical identification information used in the group that the terminal device 20x requests to join in the group joining request. Suppose in FIG. 9 that the group joining Ack includes the logical identification information used in the group that the terminal device 20x requests to join in the group joining request and information permitting the terminal device 20x to be included in the group G1. Then, the joining processing unit 52x determines that the terminal device 20x has joined the group G1. The obtaining unit 53x stores the information notified in the group joining Ack in the storage unit 60x.

In step S36, the joining processing unit 52a transmits a group information message to the devices within the group which devices are communicatable with the terminal device 20a. The group information message includes latest information about the terminal devices 20 participating in the group and the like. Each of the terminal devices 20 receiving the group information message updates information in the group accommodation table 61 and the like according to the contents of the group information message. Therefore, the devices other than the terminal device 20a which devices joined the group G1 before the joining of the terminal device 20x may recognize that the terminal device 20x has joined the group G1 based on the information notified in step S36. Further, the obtaining unit 53x in the terminal device 20x also updates information in the storage unit 60x using the information notified in step S36.

FIG. 10 is a diagram of assistance in explaining an example of message formats. M11 is an example of a message format of the group joining Ack. The group joining Ack includes the logical identification information shared in the group and the group accommodation table 61, an accommodated terminal number, an ACT/SBY information table, and ACT selection conditions that are used in the group. The accommodated terminal number is used to identify the terminal device 20 as the destination of the group joining Ack within the group. The group joining Ack transmitted in step S35 in FIG. 9 includes accommodated terminal information used to distinguish the terminal device 20x from the other terminal devices 20 in the group G1. The ACT/SBY information table is information indicating whether each of the terminal devices 20 in the group that the terminal device 20x has joined is set in an active state or in a standby state. The ACT selection conditions are used to select a terminal device 20 to retain the usage right to use the logical identification information (to be set in an active state) within the group when none of the terminal devices 20 within the group retains information to be transmitted to the base station 10. Processing using the ACT selection conditions will be described in detail when description is made of selection of the terminal device 20 that is to perform waiting processing. Incidentally, information notified as the ACT selection conditions is used for processing of synchronizing information in the selection condition table 65.

M12 is an example of a message format of group information. The group information includes the logical identification information shared in the group, the information of the group accommodation table 61 retained by a transmission source of the group information, the ACT/SBY information table, and the ACT selection conditions.

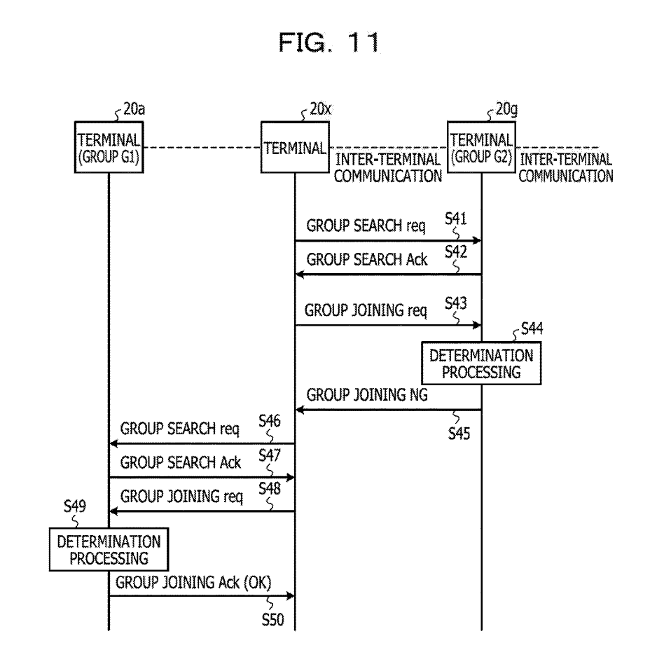

M13 is an example of a message format of a group joining ACK (group joining NG message) transmitted when joining the group is not permitted. The group joining NG message includes the logical identification information used in the group and information indicating that joining the group is not permitted. The terminal device 20 receiving the group joining NG message may therefore perform processing of, for example, requesting to join a group using logical identification information different from the logical identification information used by a transmission source of the group joining NG message. The processing of the terminal device 20 in the case of receiving the group joining NG message will be described with reference to FIG. 11.

FIG. 11 is a sequence diagram of assistance in explaining an example of processing at a time of joining a group. Suppose in the example of FIG. 11 that the terminal device 20a has joined the group G1, and that the terminal device 20g has joined the group G2.

Processing performed in steps S41 to S43 is similar to the processing of steps S21 to S23 in FIG. 6. In steps S41 to S43, the terminal device 20x is requesting the terminal device 20g to allow the terminal device 20x to join the group G2. Suppose that in step S44, the terminal device 20g determines that the terminal device 20x is not allowed to join the group G2 based on the number of terminal devices 20 in the group G2, communication states of the terminal devices 20 in the group G2, and the like. Then, the joining processing unit 52g transmits a group joining NG message including the logical identification information used in the group G2 to the terminal device 20x (step S45).

The joining processing unit 52x of the terminal device 20x obtains the group joining NG message via the D2D receiving unit 34x. The joining processing unit 52x identifies the logical identification information included in the group joining NG message. The joining processing unit 52x transmits a group search request in order to search for a group performing communication using logical identification information different from the logical identification information included in the group joining NG message (step S46). In the example of FIG. 11, a group search Ack including the logical identification information of the group G1 is transmitted from the terminal device 20a (step S47). The joining processing unit 52x determines that the logical identification information included in the group search Ack is different from the logical identification information notified in the group joining NG message. Then, the joining processing unit 52x generates a group joining request including the logical identification information included in the group search Ack obtained in step S47. The joining processing unit 52x transmits the group joining request to the terminal device 20a via the D2D transmitting unit 33x (step S48). Processing of steps S49 and S50 is similar to steps S34 and S35 described with reference to FIG. 9.

As described above, a terminal device 20 shares logical identification information by joining a group of terminal devices 20 located in the vicinity of the terminal device 20. Further, each of the terminal devices 20 within the group also shares the communication states of the respective terminal devices 20 and the like using a group information message.

(2) Communication Processing

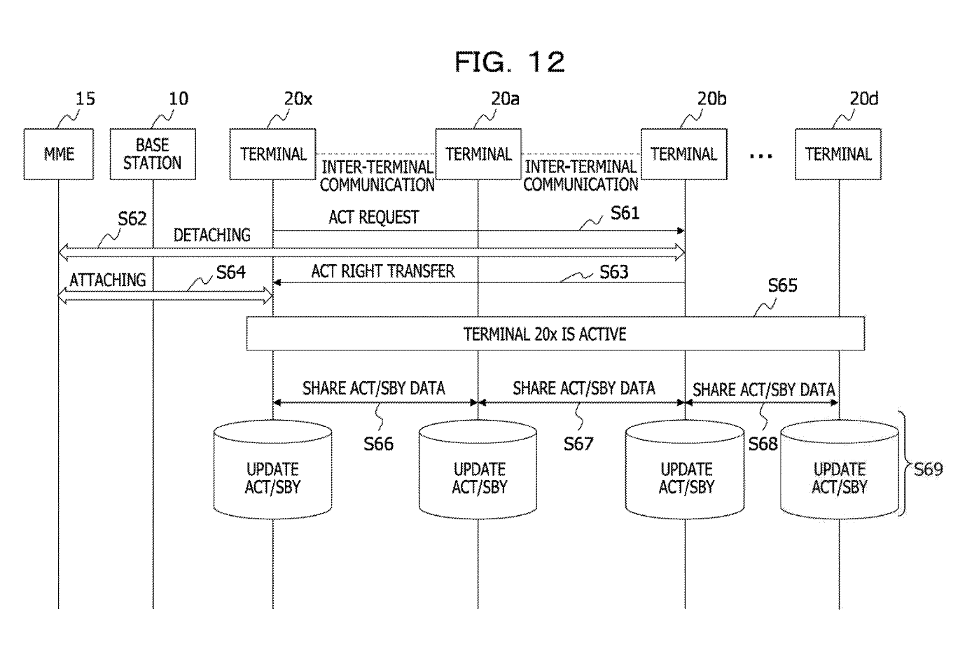

FIG. 12 is a sequence diagram of assistance in explaining an example of processing of changing a terminal device that performs communication. FIG. 12 illustrates an example of communication processing in the group G1 including a plurality of terminal devices 20 (20a to 20d and 20x). A maximum number of terminal devices 20 that may obtain the usage right to use the logical identification information 62 in the group G1 is determined in advance. Suppose that a terminal device 20 not having the usage right intends to start communication after the number of terminal devices 20 obtaining the usage right reaches the maximum number. In this case, one terminal device 20 having the usage right transfers the usage right to the terminal device 20 intending to start communication, and makes a transition to a standby state. On the other hand, the terminal device 20 to which the usage right is transferred makes a transition to an active state, and starts communication using the logical identification information 62.

Suppose that the terminal device 20b has the usage right to use the logical identification information at a first time point in FIG. 12. In addition, suppose that in the group G1, one terminal device 20 may communicate using the logical identification information 62 shared among the terminal devices 20 in the group G1. Therefore, the terminal devices 20 other than the terminal device 20b in the group G1 do not have the usage right to use the logical identification information (standby). Further, suppose that IMSI_Gxx is used as the logical identification information 62 also in the example of FIG. 12.

Suppose that data to be transmitted to the base station 10 is generated or obtained in the terminal device 20x. The requesting unit 54x in the terminal device 20x determines, using the ACT/SBY information table 63x, that the terminal device 20b is set active in the group G1. For example, at this point in time, the terminal device 20b retains the usage right to use IMSI_Gxx. Incidentally, the terminal device 20b may be communicating with the base station 10, or may be in a waiting state. The requesting unit 54x generates a message for requesting that the terminal device 20x be set active (ACT request). Here, the ACT request is a message requesting to obtain the right to perform communication using the logical identification information 62, and may therefore also be considered to be a request for the usage right to use the logical identification information 62. The requesting unit 54x transmits the ACT request to the terminal device 20b via the D2D transmitting unit 33x (step S61).

The obtaining unit 53b of the terminal device 20b obtains the ACT request via the D2D receiving unit 34b. In order to transfer the usage right to use the logical identification information 62 to the transmission source of the ACT request, the obtaining unit 53b requests the call processing unit 41b to perform coupling detaching processing via the base station 10. The call processing unit 41b performs detaching in response to the request from the obtaining unit 53b (step S62). As a result of the detaching processing, a state of coupling of the terminal device 20b to the base station 10 and a device within a core network is set in an idle state. For example, the terminal device 20b is set in an evolved packet system (EPS) connection management (ECM) idle (ECM-Idle) state, a radio resource control (RRC) idle (RRC-Idle) state, and an EPS mobility management (EMM)-deregistered state. After ending the detaching, the call processing unit 41b notifies the end of the detaching to the notification processing unit 55b. The notification processing unit 55b generates a message for notifying the transfer of the right to communicate using the logical identification information 62 (ACT right transfer). An example of information elements included in the ACT right transfer message will be described later. The notification processing unit 55b transmits the ACT right transfer message to the terminal device 20x via the D2D transmitting unit 33b (step S63). In parallel with the processing of step S63, the notification processing unit 55b changes the active terminal device 20 from the terminal device 20b to the terminal device 20x in the ACT/SBY information table 63b.

The obtaining unit 53x of the terminal device 20x obtains the ACT right transfer message via the D2D receiving unit 34x. The obtaining unit 53x updates the ACT/SBY information table 63x by using the ACT right transfer message received in step S63. Because the terminal device 20x is set active, the requesting unit 54x determines that the terminal device 20x may use IMSI_Gxx. Then, the requesting unit 54x requests the call processing unit 41x to perform attaching processing using the logical identification information 62. The call processing unit 41x performs attaching processing between the call processing unit 41x and the MME 15 using the logical identification information 62 (step S64). As a result of the attaching processing in step S64, the terminal device 20x obtains a GUTI to be used for communication from the MME 15. Suppose in the example of FIG. 12 that the terminal device 20x obtains GUTI_Gxy. Then, the terminal device 20x may perform processing of communicating with the base station 10 using the logical identification information 62 (IMSI_Gxx) and GUTI_Gxy.

Here, the identification information used by the terminal device 20x and the identification information used by the device (terminal device 20b) in the group G1 which device (terminal device 20b) was active before the terminal device 20x are both IMSI_Gxx. The MME 15 and the base station 10 therefore perform processing as in a case where the terminal device 20x and the terminal device 20b are an identical terminal.

Meanwhile, the notification processing unit 55b of the terminal device 20b and the notification processing unit 55x of the terminal device 20x notify the other terminal devices 20 belonging to the group G1 of the ACT/SBY information table 63 notifying that the terminal device 20x is active (step S65). For example, the notification processing unit 55x in the terminal device 20x notifies the information of the ACT/SBY information table 63x to the terminal device 20a (step S66). Meanwhile, the notification processing unit 55b in the terminal device 20b notifies the information of the ACT/SBY information table 63b to the terminal device 20d and the terminal device 20a (steps S67 and S68). Therefore, the terminal device 20a and the terminal device 20d obtaining the information of the ACT/SBY information table 63 from the terminal device 20x and the terminal device 20b also recognize that the terminal device 20x is active. The obtaining unit 53 in each of the terminal device 20a and the terminal device 20d updates the information of the ACT/SBY information table 63 by using the obtained information. Further, each of the terminal devices 20 in the group G1 performs processing of synchronizing the information of the ACT/SBY information table 63 and the like with the other terminal devices 20. As a result, the latest information of the ACT/SBY information table 63 is stored in each of the devices in the group G1 (step S69).

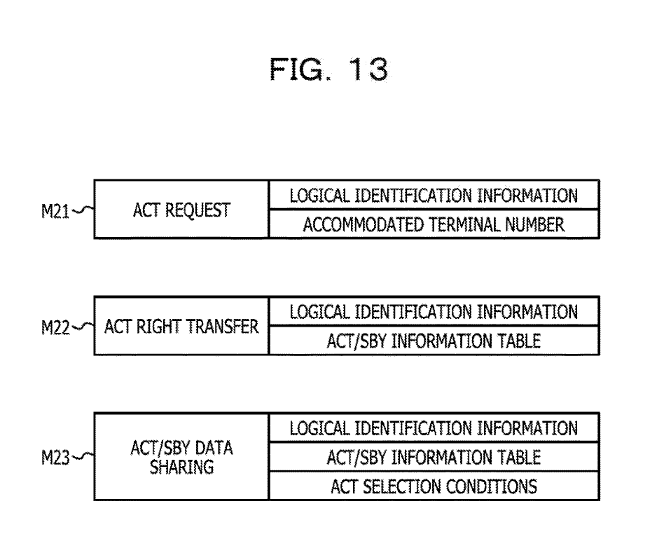

FIG. 13 is a diagram of assistance in explaining an example of message formats. FIG. 13 illustrates an example of formats of the messages transmitted and received in the processing illustrated in FIG. 12. M21 is an example of a message format of the ACT request. The ACT request includes the logical identification information shared in the group and an accommodated terminal number, together with information usable to identify the kind of the message. The accommodated terminal number in the ACT request is a number assigned to the terminal device 20 requesting to be set and changed to an active state. Incidentally, the ACT request may use arbitrary information that is able to identify the terminal device 20 requesting to be set and changed to an active state in place of the accommodated terminal number.

M22 is an example of a message format of the ACT right transfer message. The ACT right transfer message includes the logical identification information shared in the group and the ACT/SBY information table, together with information usable to identify the kind of the message. When the ACT right transfer message indicated by M22 is used, a device receiving the ACT right transfer message such as the terminal device 20x in FIG. 12 determines whether the own device is set active, by using the ACT/SBY information table 63 in the message. When the own device is set active in the ACT right transfer message, the terminal device 20 receiving the ACT right transfer message determines that the terminal device 20 has obtained the usage right to use the logical identification information 62.

M23 is an example of a message format of an ACT/SBY data sharing message. The ACT/SBY data sharing message includes the logical identification information used in the group, the ACT/SBY information table 63, and the ACT selection conditions.

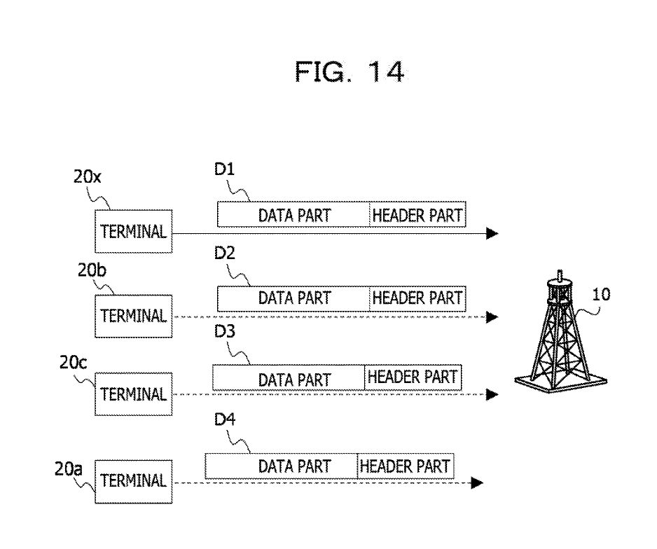

FIG. 14 is a diagram of assistance in explaining an example of processing of transmitting data to a base station. The base station illustrated in FIG. 14 may be the base station 10 illustrated in FIG. 2. Suppose that the terminal device 20x is active in the group G1 as a result of the processing described with reference to FIG. 12 and FIG. 13. The data processing unit 42x generates user data D1. At this time, the data processing unit 42x secures a part of the user data D1 as a region (header part) in which to include information that may identify the terminal device 20x as a transmission source. The user data D1 therefore includes a data part and a header part. The data part stores data transmitted from the terminal device 20x. The header part may store arbitrary information that is able to identify the terminal device 20x as a transmission source. For example, the header part in the user data D1 may store the IMSI assigned to the terminal device 20x. In a case where the information of the data part in the user data D1 is data processed for each terminal device 20 such as charging information, a device in the core network may identify the terminal device 20 as a transmission source by using the transmission source terminal information of the data in the header.

When the active terminal device 20 is changed in the group G1, a terminal device 20 changed to an active state may transmit user data including a header part and a data part as with the terminal device 20x. In the example of FIG. 14, the terminal device 20b transmits user data D2. In addition, the terminal device 20c transmits user data D3, and the terminal device 20a transmits user data D4. Incidentally, information elements included in the header part in the user data transmitted from each of the terminal devices 20 are arbitrary identification information that may identify the terminal device 20 as a transmission source.

Here, the logical identification information is used for coupling processing and the like irrespective of whether the user data includes information identifying the respective terminal devices 20. Therefore, the base station 10 and the MME 15 treat all of the terminal device 20x, the terminal device 20b, the terminal device 20c, and the terminal device 20a as a device identified by IMSI_Gxx. Hence, the plurality of terminal devices 20 may communicate with the base station 10 while a load of coupling management or the like at the base station 10 is suppressed to substantially the same level as that of processing for one terminal device 20.

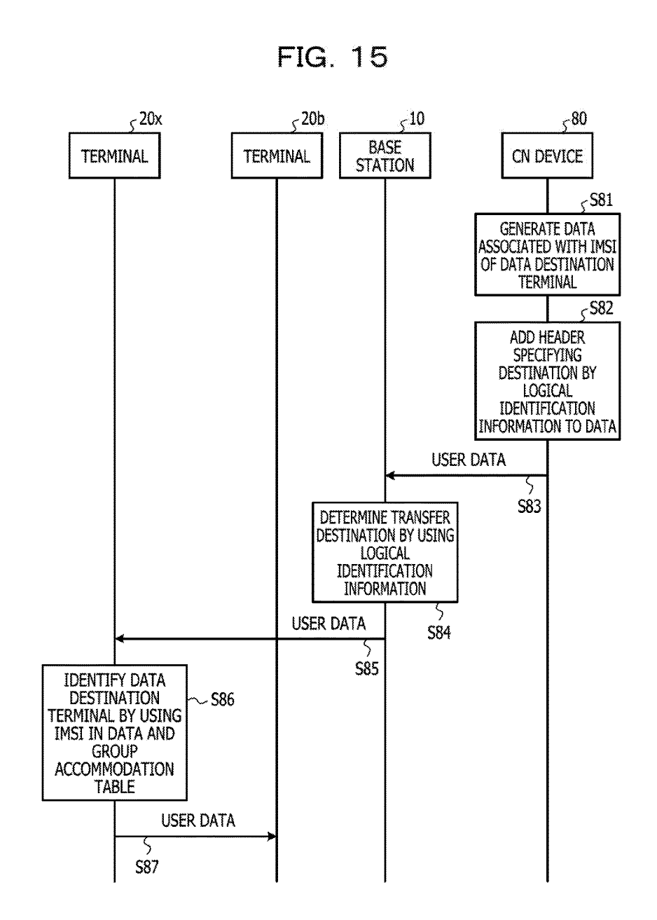

FIG. 15 is a sequence diagram of assistance in explaining an example of processing of receiving data from a base station. The base station illustrated by reference to FIG. 15 may be the base station 10 illustrated in FIG. 2. A device in the core network (CN device) associates data addressed to each terminal device 20 with information identifying the destination terminal device 20. An example of reception processing will be described in the following by taking as an example a case where data is sent from the CN device 80 to the terminal device 20b. Incidentally, suppose in FIG. 15 that the terminal device 20x is set active.

The CN device 80 generates data for transmission, the data being associated with the IMSI of a destination terminal (step S81). For example, the CN device 80 generates data addressed to the terminal device 20b and including the IMSI of the terminal device 20b (IMSIb). The CN device 80 next adds a header specifying a destination by the logical identification information to the generated data (step S82). In the example of FIG. 15, a header including IMSI_Gxx used in the group G1 and GUTI_Gxy is added to the data. The CN device 80 transmits the data after the addition of the header thereto to the destination (step S83).

The data transmitted from the CN device 80 arrives at the base station 10. When the base station 10 obtains the data from the CN device 80, the base station 10 determines a transfer destination by using the logical identification information and the like included in the header (step S84). In the example of FIG. 15, the header including IMSI_Gxx and GUTI_Gxy is used. The base station 10 therefore recognizes the terminal device 20 active in the group G1 as the transfer destination. Accordingly, the base station 10 transfers the data obtained from the CN device 80 to the terminal device 20x (step S85). Incidentally, GUTI_Gxy is used for the base station 10 to call the terminal device 20x.

The data processing unit 42x of the terminal device 20x identifies the terminal device 20b as the destination terminal device 20 for the data, by using the IMSI in the data received from the CN device 80 and the group accommodation table 61 (step S86). The terminal device 20x transfers the received data to the terminal device 20b (step S87). The data transmitted from the CN device 80 to the terminal device 20b therefore reaches the terminal device 20b.

(3) Selecting Terminal Device 20 to Perform Waiting Processing

When none of terminal devices 20 in a group is performing communication, a terminal device 20 that is to perform waiting processing for data reception via the base station 10 is selected using the selection condition table 65.

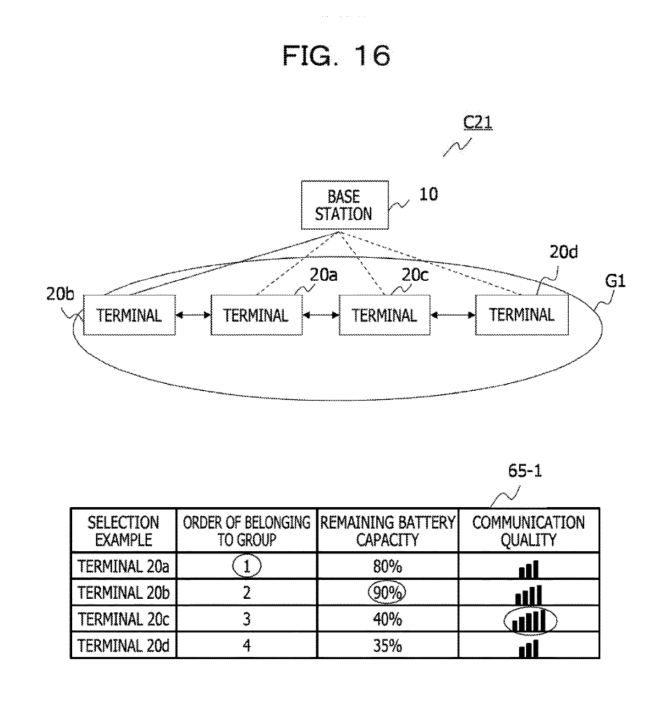

FIG. 16 is a diagram of assistance in explaining an example of processing of updating a selection condition table and an example of the selection condition table. The selection condition table illustrated in FIG. 16 may be the selection condition table 65 illustrated in FIG. 3. At a time of ACT/SBY data synchronization, the terminal devices 20 in the group perform processing of synchronizing also information about the communication states of the respective terminal devices 20 and the like. As an example, as indicated by a case C21, suppose that the terminal devices 20a to 20d belong to the group G1. Suppose in FIG. 16 that the terminal device 20b has the usage right to use the logical identification information 62. For example, the terminal device 20b is set active. In FIG. 16, a coupling between the active terminal device 20b and the base station 10 is made by a solid line, and couplings between the terminal devices 20 in a standby state and the base station 10 are made by broken lines.

In the case C21, arrows indicate a state in which each terminal device 20 in the group G1 synchronizes the data in the ACT/SBY information table 63 and the communication states with adjacent terminal devices 20. Incidentally, while the arrows indicate a part of communications for ease of viewing of FIG. 16, inter-terminal communications may be performed also between devices not indicated by the arrows. For example, as for the terminal device 20a, communications with the terminal device 20b and the terminal device 20c are indicated by arrows, but a communication between the terminal device 20a and the terminal device 20d is not indicated. However, when communication between the terminal device 20a and the terminal device 20d is possible, communication processing may also be performed between the terminal device 20a and the terminal device 20d. The same is true for the other terminal devices 20. Incidentally, each of the terminal devices 20 may notify not only information about the own device but also information about the other terminal devices 20 which information the device has already obtained. For example, after the terminal device 20a obtains communication information from the terminal device 20c, the terminal device 20a may collectively notify the terminal device 20b of the communication states of the terminal device 20a and the terminal device 20c.

When the obtaining unit 53 in each of the terminal devices 20 obtains the communication states of the respective terminal devices 20 in the group by synchronization processing, the obtaining unit 53 records the obtained information in the selection condition table 65. In an example of a selection condition table 65-1, order of belonging to the group, remaining battery capacity, and communication quality are recorded for each of the terminal devices 20 whose information is obtained. In the example of FIG. 16, the terminal device 20a belongs to the group G1 first, has a remaining battery capacity of 80%, and has a communication quality at a third level on a scale of five levels. The terminal device 20b joins the group G1 second, has a remaining battery capacity of 90%, and has a communication quality at a fourth level on the scale of five levels. The terminal device 20d joins the group G1 third, has a remaining battery capacity of 40%, and has a communication quality at a fifth level on the scale of five levels. Further, the terminal device 20c joins the group G1 fourth, has a remaining battery capacity of 35%, and has a communication quality at a third level on the scale of five levels. Therefore, when a terminal device 20 that is to perform waiting processing is selected in the order of belonging to the group, the terminal device 20a is selected as a device that is to perform waiting processing. On the other hand, when a terminal device 20 that is to perform waiting processing is determined in the order of remaining battery capacity, the terminal device 20b is selected. When a terminal device 20 that is to perform waiting processing is selected in the order of communication quality, the terminal device 20d is selected as a device that is to perform waiting processing.

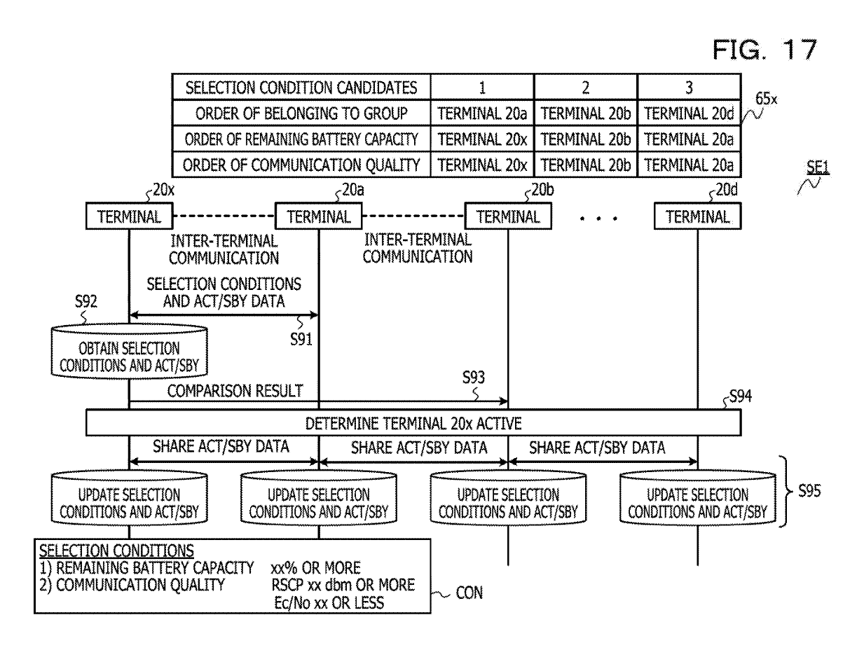

FIG. 17 is a diagram of assistance in explaining an example of a method of determining a terminal device that is to perform waiting processing. Suppose for example that the terminal device 20x has joined the group G1 as a result of processing similar to the processing described with reference to FIG. 9. In addition, suppose that the terminal device 20x does not retain information to be transmitted to the base station 10 when joining the group G1, and therefore is not requesting a setting thereof to be changed to an active state. Further, suppose that none of the terminal devices 20 in the group G1 is communicating with the base station 10, and that the terminal device 20b is therefore performing waiting processing for data addressed to any of the terminal devices 20 belonging to the group G1.

After successfully joining the group G1, the terminal device 20x obtains, from the terminal device 20a, the selection conditions used in the group G1 and data indicating the setting states of the respective devices in the group G1 (ACT/SBY data) (step S91). Suppose in the example of FIG. 17 that information in the selection condition table 65-1 (FIG. 16) is also notified to the terminal device 20x at a time of processing in step S91. The obtaining unit 53x in the terminal device 20x stores the obtained information in the storage unit 60x (step S92). Therefore, as illustrated in FIG. 17, the selection condition table 65x includes the communication information of the terminal device 20x and information of the other terminal devices 20 (20a to 20d) in the group G1. Incidentally, in FIG. 17, the information in the selection condition table 65x is sorted according to selection conditions, and is illustrated as information about top three terminals for each of the selection conditions. For example, as for the order of belonging to the group G1, the terminal device 20a joins earliest, and the terminal device 20b and the terminal device 20d subsequently join. Suppose that remaining battery capacity is decreased in order of the terminal device 20x, the terminal device 20b, and the terminal device 20a. In addition, suppose that the terminal device 20x has a best communication quality, and that the communication quality of the terminal device 20b and the terminal device 20a is decreased in this order.

Here, suppose that the terminal device 20x that has newly joined the group G1 does not retain transmission data, nor do the other terminal devices 20 belonging to the group G1 retain transmission data. In this case, processing of selecting a terminal device 20 to perform waiting processing is performed. With respect to conditions notified as the selection conditions in step S91, the requesting unit 54x in the terminal device 20x that has newly joined the group compares states of the active terminal device 20b with states of the terminal device 20x itself. In the comparison processing, the requesting unit 54x may use the information retained in the selection condition table 65x.

Suppose in the example of FIG. 17 that conditions indicated by CON are used as the selection conditions. For example, the selection conditions are that remaining battery capacity be xx% and that received signal code power (RSCP) be equal to or more than xx dbm and energy per chip over the noise (Ec/No) (or a ratio of power to noise) be xx or less. Further, suppose in the example of FIG. 17 that a terminal device 20 having a better state corresponding to the condition (1) among terminal devices 20 that meet both of the conditions of (1) and (2) as the selection conditions is given priority as a terminal device 20 that is to perform waiting processing.

The requesting unit 54x in the terminal device 20x compares a combination of the remaining battery capacity and communication quality of the terminal device 20b with a combination of the remaining battery capacity and communication quality of the terminal device 20x, and notifies a result of the comparison to the active terminal device 20b (step S93). In the example of FIG. 17, as indicated by the selection condition table 65x, the remaining battery capacity and communication quality of the terminal device 20x are both better than those of the terminal device 20b. Therefore, the requesting unit 54x determines that the terminal device 20x is to perform waiting processing, and requests the terminal device 20b to change the active terminal. Processing for changing a setting to an active state is similar to the processing described with reference to FIG. 12.

The terminal device 20b and the terminal device 20x notify a result of changing the terminal device 20 performing waiting processing to the other terminal devices 20 in the group G1, such as the terminal device 20a, and the terminal device 20d. All of the terminals in the group G1 therefore determine that the device performing waiting processing is the terminal device 20x (step S94). The processing of synchronizing the selection conditions and the latest information in the ACT/SBY information table 63 is also thereafter performed as appropriate between the terminal devices 20 in the group G1. Each of the terminal devices 20 stores the ACT/SBY data and the selection conditions obtained as a result of the synchronization processing in the storage unit 60 (step S95).

The terminal device 20x selected as the terminal device 20 that performs waiting processing in the group G1 receives data as a representative of the other terminal devices 20 in the group G1. Further, using information associated with the received data, the terminal device 20x transfers the received data to a terminal device 20 as a destination of the data.

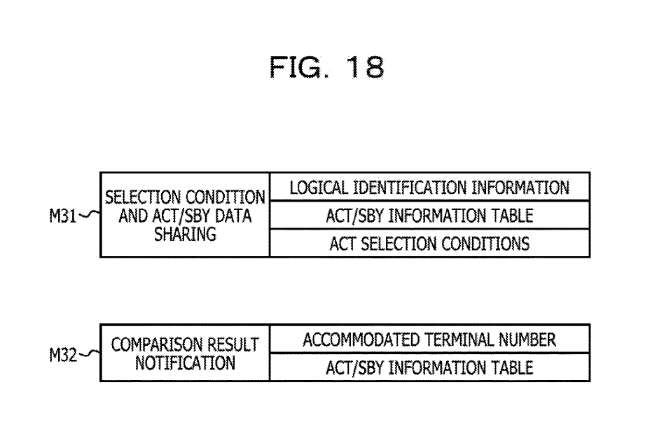

FIG. 18 is a diagram of assistance in explaining an example of message formats. FIG. 18 is an example of messages used in the processing described with reference to FIG. 17. M31 is an example of a format of a message transmitted and received between terminal devices 20 when the selection conditions and the ACT/SBY data are shared in step S91 in FIG. 17 (data sharing message). In addition to information indicating the kind of the message, the data sharing message includes the logical identification information used in the group as well as the ACT/SBY information table 63 and the ACT selection conditions retained by the terminal device 20 as the transmission source.

Incidentally, the message transmitted and received when the selection conditions and the ACT/SBY data are shared may be used as the ACT/SBY data sharing message used for data synchronization in the group (M23 in FIG. 13). The ACT/SBY data sharing message may be used to share the ACT/SBY information within the group in step S95 in FIG. 17, steps S66 to S68 in FIG. 12, or the like.

M32 is an example of a format of a comparison result notification message. The comparison result notification message is used in step S93 in FIG. 17. The comparison result notification message includes a result of the comparison processing and information that may identify the terminal device 20 to be set active. In the example of FIG. 18, the information in the ACT/SBY information table 63 when reflecting the comparison result is included as the comparison result. For example, in the case of step S93 in FIG. 17, the comparison result notification message includes the accommodated terminal number assigned to the terminal device 20x and a copy of the ACT/SBY information table 63x. Incidentally, because the selection condition comparison processing between the terminal device 20x and the terminal device 20b is performed in the terminal device 20x, the ACT/SBY information table 63x records that the terminal device 20x is selected to be active as a result of the comparison processing. Therefore, based on these pieces of information, the terminal device 20b may recognize that the terminal device 20x is set active.

It is to be noted that while an example of the processing of selecting a terminal device 20 to perform waiting processing has been described with reference to FIG. 17 and FIG. 18 by taking, as an example, processing in a case where the conditions CON in FIG. 17 are used, conditions used to select a terminal device 20 to perform waiting processing may be changed arbitrarily according to implementations. For example, a terminal device 20 that is to perform waiting processing may be selected from one condition selected from the conditions of the order of belonging to the group, the order of remaining battery capacity, and the order of communication quality. In addition, a terminal device 20 that is to perform waiting processing may be selected using a combination of a plurality of conditions.

(4) Withdrawal from Group

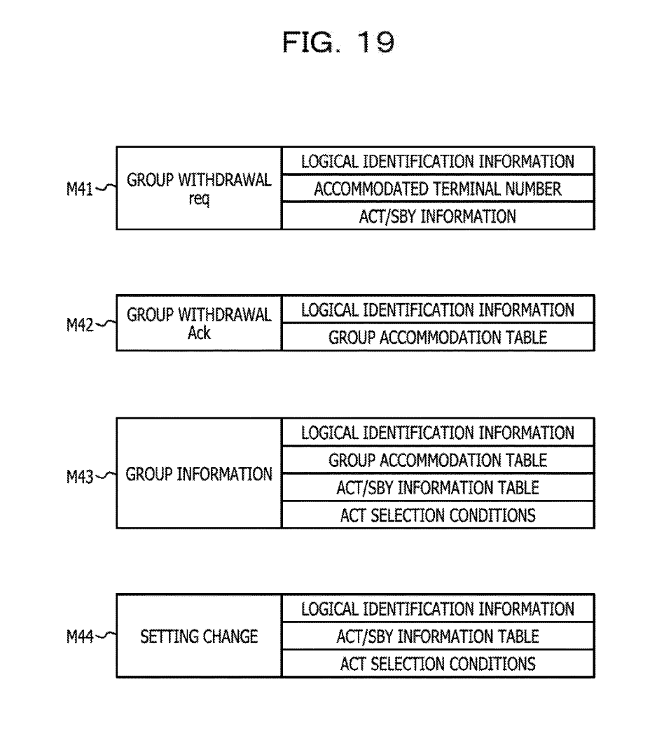

FIG. 19 is a diagram of assistance in explaining an example of formats of messages that may be used at a time of processing of withdrawal from a group. M41 is an example of a format of a group withdrawal request. A terminal device 20 that requests to withdraw from the group transmits a group withdrawal request. The group withdrawal request includes the logical identification information of the group, the accommodated terminal number assigned to the terminal device 20 that intends to withdraw from the group, and ACT/SBY information. Incidentally, information about the terminal device 20 that intends to withdraw from the group is deleted from the ACT/SBY information.

M42 is an example of a format of a group withdrawal Ack. A terminal device 20 having received the group withdrawal request transmits the group withdrawal Ack. The group withdrawal Ack includes the logical identification information of the group and the group accommodation table 61 after the information notified in the group withdrawal request is reflected in the group accommodation table 61.

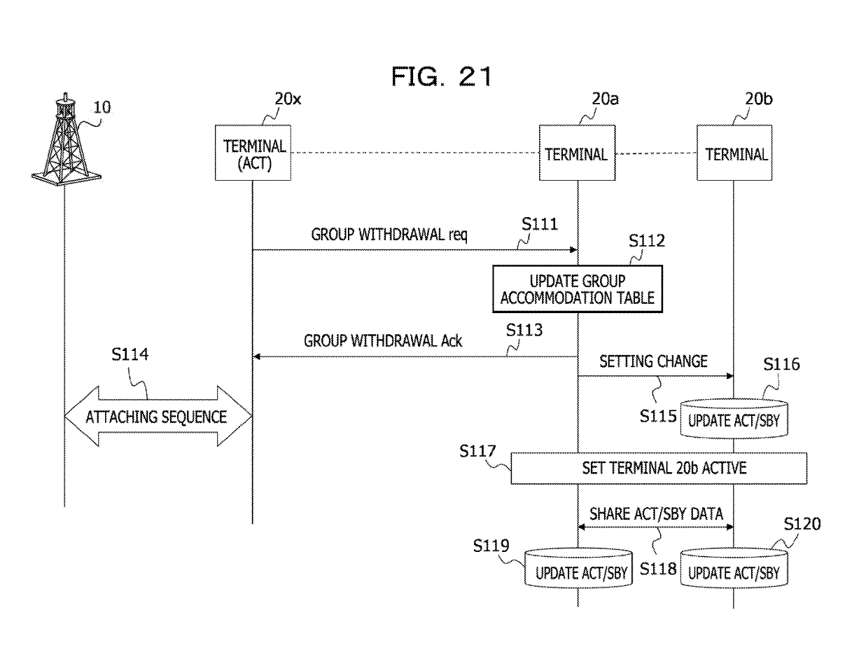

M43 is a group information message that the terminal device 20 having received the group withdrawal request transmits to the other terminal devices 20 in the group. Information elements in the group information message are similar to those when a terminal device 20 joins a group (M12 in FIG. 10). For example, as the terminal device 20 withdraws from the group, processing of synchronizing the logical identification information, the group accommodation table, the ACT/SBY information table, and the ACT selection conditions is performed between the terminal devices 20 belonging to the group. M44 is an example of information elements included in a setting change message. The setting change message is used to select a terminal device 20 to be set active when a terminal device 20 set active withdraws. The setting change message includes the logical identification information, the ACT/SBY information table, and the ACT selection conditions. Details of processing when the setting change message is used will be described with reference to FIG. 21.

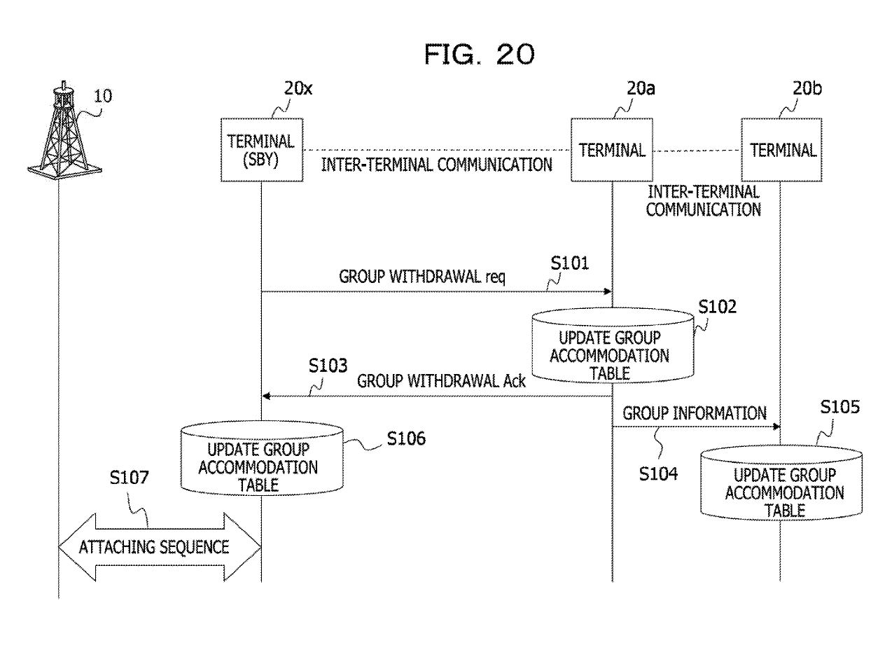

FIG. 20 is a diagram of assistance in explaining an example of processing when a terminal device set in a standby state withdraws from a group. The terminal device illustrated in FIG. 20 may be the terminal device 20 illustrated in FIG. 2. Incidentally, also in the following example, description will be made by taking, as an example, processing in the group G1 including the terminal devices 20a to 20d and the terminal device 20x.

Suppose that the strength of signals received by the terminal device 20x from terminal devices 20 in the group G1 becomes weak due to a change in the position of the terminal device 20x as a result of movement of an installation position of an apparatus incorporating the terminal device 20x or the like. When the received signal strength becomes less than a threshold value, the joining processing unit 52x decides to withdraw from the group, and deletes information about the terminal device 20x from the ACT/SBY information table 63x. The joining processing unit 52x generates a group withdrawal request (M41 in FIG. 19) using the ACT/SBY information table 63x after the update. The group withdrawal request generated at this time includes the logical identification information of the group G1, the accommodated terminal number assigned to the terminal device 20x, and information in the ACT/SBY information table 63x after the update. The D2D transmitting unit 33x transmits the generated group withdrawal request (step S101).

The obtaining unit 53a of the terminal device 20a obtains the group withdrawal request via the D2D receiving unit 34a. Using the information in the group withdrawal request, the obtaining unit 53a deletes the terminal device 20x from the ACT/SBY information table 63a. The obtaining unit 53a updates information about the group G1 by deleting information about the terminal device 20x also from the group accommodation table 61a (step S102). The notification processing unit 55a generates a group withdrawal Ack (M42 in FIG. 19) responding to the group withdrawal request. The group withdrawal Ack includes the logical identification information of the group G1 and a copy of the group accommodation table 61a. The D2D transmitting unit 33a transmits the group withdrawal Ack to the terminal device 20x (step S103).

Further, the notification processing unit 55a in the terminal device 20a generates a group information message (M43 in FIG. 19) for notifying the other terminal devices 20 in the group G1 of the withdrawal of the terminal device 20x. The group information message includes the logical identification information of the group G1, information in the group accommodation table 61a, information in the ACT/SBY information table 63a, and the ACK selection conditions. At a point in time of the generation of the group information message, the information about the terminal device 20x is deleted from both of the group accommodation table 61a and the ACT/SBY information table 63a. The terminal devices 20 that receive the group information message may therefore be notified of the withdrawal of the terminal device 20x. The D2D transmitting unit 33a transmits the group information message to the terminal devices 20b to 20d (step S104).

When receiving the group information message, the obtaining unit 53b in the terminal device 20b updates the group accommodation table 61b and the ACT/SBY information table 63b by using the received information (step S105). Though not illustrated for ease of viewing of FIG. 20, the terminal device 20c and the terminal device 20d also perform processing similar to that of the terminal device 20b. Therefore, the terminal devices 20b to 20d also recognize that the terminal device 20x has withdrawn from the group G1.

Meanwhile, the terminal device 20x receives the group withdrawal Ack from the terminal device 20a. The obtaining unit 53x in the terminal device 20x confirms that the terminal device 20x is not included in the group accommodation table in the group withdrawal Ack. The obtaining unit 53x updates the group accommodation table 61x according to the information in the group withdrawal Ack (step S106). Incidentally, in the processing of step in S106, because the terminal device 20x itself withdraws from the group G1, information about the terminal devices 20a to 20d belonging to the group G1 is deleted from the group accommodation table 61x. The terminal device 20x thereafter performs a search for a new group to join or the like. When the terminal device 20x does not find a new group to join, the terminal device 20x generates a group to which the terminal device 20x belongs, and performs the processing of an attaching sequence between the terminal device 20x and the base station 10 (step S107). Details of the processing performed in step S107 are similar to those of the processing described with reference to FIG. 5.

FIG. 21 is a diagram of assistance in explaining an example of processing when a terminal device set active withdraws from a group. The terminal device illustrated in FIG. 21 may be the terminal device 20 illustrated in FIG. 2. The following description will be made of an example in which the terminal device 20x in a state of having the usage right to use the logical identification information 62 withdraws from the group G1. Incidentally, also in the following example, suppose that the group G1 includes the terminal devices 20a to 20d and the terminal device 20x. Processing of steps S111 to S113 is similar to the processing of steps S101 to S103 described with reference to FIG. 20. In addition, processing of step S114 is similar to the processing of step S107 described with reference to FIG. 20. Incidentally, before the processing of step S114, also in the case of FIG. 21, the terminal device 20x updates the group accommodation table 61x by processing similar to the processing described with reference to step S106 in FIG. 20.

Because the terminal device 20x as a transmission source of a group withdrawal request is the active terminal device 20, the notification processing unit 55a of the terminal device 20a decides to set a terminal device 20 to be newly active. Using information in the selection condition table 65a, the notification processing unit 55a compares the communication states and the like of the devices in the group G1 with each other, the communication states and the like being set as the ACK selection conditions. The notification processing unit 55a notifies a result of the comparison to a terminal device 20 determined to be desirably set active from the selection condition table 65a. Suppose in the example of FIG. 21 that the terminal device 20b is desirably set active. The notification processing unit 55a therefore sets the terminal device 20b active, by updating the ACT/SBY information table 63a. The result of the comparison of the communication states and the like in the terminal device 20a is notified to the terminal device 20b by using a setting change message (M44 in FIG. 19) (step S115). The setting change message includes the logical identification information of the group G1, a copy of the ACT/SBY information table 63a after the update, and the ACT selection conditions.

When receiving the setting change message, the obtaining unit 53b of the terminal device 20b updates the ACT/SBY information table 63b according to the copy of the ACT/SBY information table 63a in the setting change message (step S116). The terminal device 20b is therefore set active also in the ACT/SBY information table 63b. Thereafter, the processing of synchronizing the selection conditions and the latest information in the ACT/SBY information table 63 is performed between the terminal devices 20 in the group G1. Each of the terminal devices 20 stores the ACT/SBY data and the selection conditions obtained as a result of the synchronization processing in the storage unit 60. The terminal device 20b is thus set active (step S117). Also, thereafter, the synchronization processing is periodically performed between the terminal devices 20 in the group G1, and the information in the ACT/SBY information table 63 is updated as appropriate (steps S118 to S120).

As described above, when the first embodiment is used, a given number of terminal devices 20 of each group communicate with the base station 10 using the logical identification information shared in the group. Hence, it suffices for the base station 10 to manage, as coupling destinations, information about the given number of terminal devices 20 of each group. The communication method according to the first embodiment therefore reduces a processing load on the base station 10 as compared with a case where each individual terminal device 20 communicates with the base station 10. Further, each individual terminal device 20 intending to communicate with the base station 10 communicates with the base station 10 after being set and changed to an active state. Therefore, concentration of loads on a particular terminal device 20 is avoided.

In the first embodiment, whether to allow a terminal device 20 requesting to join a group to join the group is determined using information such as a total number of terminal devices 20 in the group and traffic in the group as a whole. There is thus another advantage in that a deviation of throughput due to variation in the number of terminal devices 20 included in each group or variation in traffic in each group does not easily occur between groups.

### Second Embodiment

In a second embodiment, description will be made of a case of further reducing a processing load by avoiding detaching processing performed by a terminal device 20 that has been active and attaching processing performed by a terminal device 20 that becomes newly active each time the active terminal device 20 is changed. In the second embodiment, a GUTI used for communication is also shared between terminal devices 20 included in a group as well as logical identification information 62. Therefore, data transmitted and received between terminal devices 20 belonging to the group includes a user equipment (UE) context. The GUTI used for communication is included in the UE context. Therefore, by sharing the UE context, terminal devices 20 in each group may communicate with a base station 10 using the same IMSI and the same GUTI.

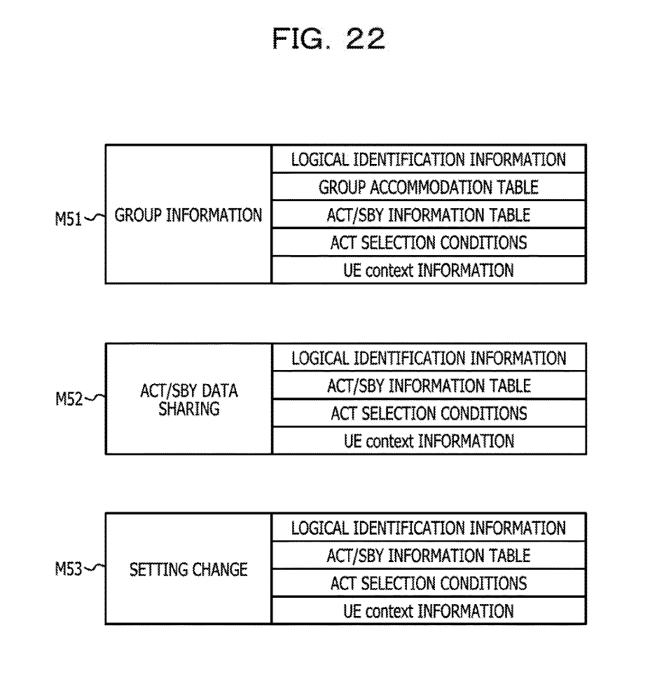

FIG. 22 is a diagram of assistance in explaining an example of messages used in the second embodiment. M51 represents an example of a group information message used in the second embodiment. The group information message includes UE context information, and further includes logical identification information, a group accommodation table, an ACT/SBY information table, and ACT selection conditions.

M52 is an example of a message format of an ACT/SBY data sharing message used in the second embodiment. The ACT/SBY data sharing message includes the UE context information, the logical identification information, the ACT/SBY information table, and the ACT selection conditions. M53 is an example of information elements included in a setting change message. The setting change message includes the UE context information, the logical identification information, the ACT/SBY information table, and the ACT selection conditions.

Incidentally, joining a group and withdrawal from the group in the second embodiment are similar to those of the first embodiment. Therefore, messages used to join a group and messages transmitted and received between a terminal device 20 withdrawing from the group and a terminal device 20 in the group are similar to those of the first embodiment.

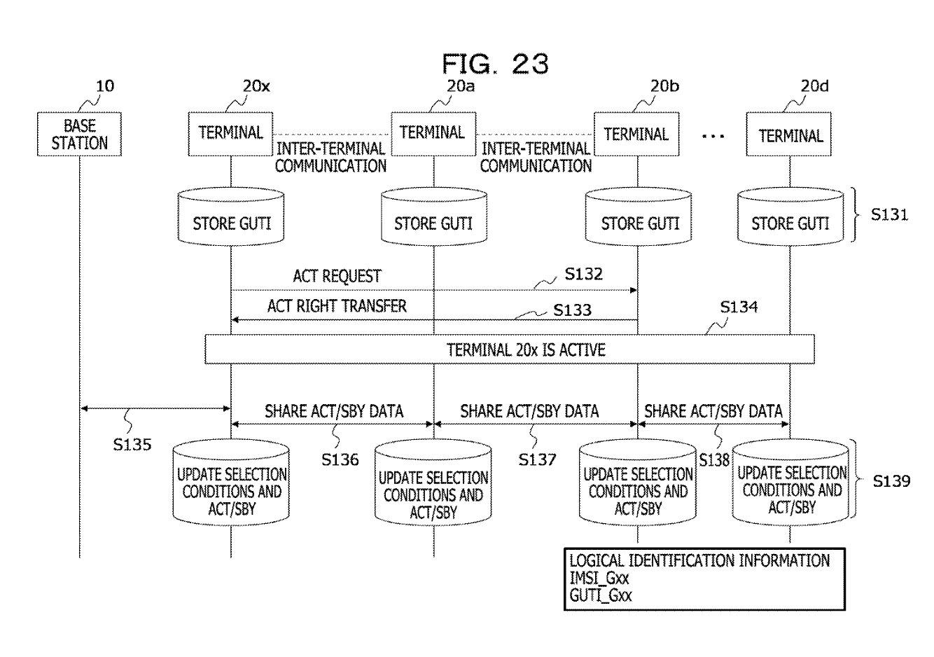

FIG. 23 is a sequence diagram of assistance in explaining an example of communication processing. FIG. 23 illustrates an example of communication processing in the group G1 including a plurality of terminal devices 20 (20a to 20d and 20x). Suppose that at a first time point in FIG. 23, the terminal device 20b is set as an active terminal device 20, and the other terminal devices 20 in the group G1 are set in a standby state. FIG. 23 also illustrates, as an example, a case where one terminal device 20 has a usage right to use the logical identification information 62 and the UE context. However, the number of devices that may retain the usage right at a time in a group may be changed according to implementations.

In the second embodiment, messages including the UE context are transmitted and received between the terminal devices 20 that have joined the group, as indicated by M51 and M52 in FIG. 22. Therefore, the terminal devices 20 in the group store the logical identification information 62 and the GUTI in advance (step S131). Suppose in the following that IMSI_Gxx and GUTI_Gxx are used to identify the group G1.

Suppose that data to be transmitted to the base station 10 is generated in the terminal device 20x. The requesting unit 54x in the terminal device 20x determines, by using the ACT/SBY information table 63x, that the terminal device 20b is set active. That is, at this point in time, the terminal device 20b retains the usage right to use IMSI_Gxx and GUTI_Gxx. Accordingly, the requesting unit 54x generates an ACT request (M21 in FIG. 13) to request that the terminal device 20x be set active. The requesting unit 54x transmits the ACT request to the terminal device 20b via the D2D transmitting unit 33x (step S132).

The obtaining unit 53b of the terminal device 20b obtains the ACT request via the D2D receiving unit 34b. The obtaining unit 53b generates an ACT right transfer message (M22 in FIG. 13) to transfer the usage right to use the logical identification information 62 to the transmission source of the ACT request. The notification processing unit 55b transmits the ACT right transfer message to the terminal device 20x via the D2D transmitting unit 33b (step S133). In parallel with the processing of step S133, the notification processing unit 55b changes the active terminal device 20 from the terminal device 20b to the terminal device 20x in the ACT/SBY information table 63b.

The obtaining unit 53x of the terminal device 20x obtains the ACT right transfer message via the D2D receiving unit 34x. The obtaining unit 53x updates the ACT/SBY information table 63x using the ACT right transfer message received in step S133. The notification processing unit 55x in the terminal device 20x transmits an ACT/SBY data sharing message to a terminal device 20 that may communicate with the terminal device 20x in the group G1. Further, the notification processing unit 55b in the terminal device 20b also transmits the ACT/SBY data sharing message to a terminal device 20 that may communicate with the terminal device 20b in the group G1. In addition, the terminal devices 20 that receive the ACT/SBY data sharing message notify the notified information to the other terminal devices 20. Therefore, in all of the terminal devices 20 belonging to the group G1, the terminal device 20x is set as the active terminal device 20 (step S134).

The terminal device 20x thereafter communicates with the base station 10 using IMSI_Gxx and GUTI_Gxx usable in the group G1 (step S135). Also, after the communication between the base station 10 and the terminal device 20x, synchronization processing using the ACT/SBY data sharing message is performed within the group G1 as appropriate (steps S136 to S138). The selection conditions, the ACT/SBY information table 63, and the like are therefore synchronized in all of the terminal devices 20a to 20d and the terminal device 20x belonging to the group G1 (step S139).

Thus, in the communication processing according to the second embodiment, the terminal devices 20 within the group share the logical identification information 62 and the UE context. Therefore, neither attaching processing nor detaching processing occurs when the active terminal device 20 is changed. A processing load imposed on the base station 10 is therefore further reduced. In addition, also in the second embodiment, as in the first embodiment, the base station 10 may treat each group as a given number of terminal devices 20. The processing load on the base station 10 is thus reduced.

<Others>

It is to be noted that the embodiments are not limited to the foregoing, but may be modified in various manners. Some of examples of the modifications will be described in the following.

The method of selecting a terminal device 20 that is to perform waiting processing is not limited to the method described in the first embodiment. For example, a terminal device 20 that last performs processing of communication with the base station 10 may start waiting processing when the communication is ended.

The above description has been made of a case where a request for the usage right to use the logical identification information 62 is notified to a terminal device 20 set active. However, this is also a mere example. For example, the request for the usage right to use the logical identification information 62 (ACT request) may be broadcast within the group. In this case, even when communication with the terminal device 20 set active is temporarily interrupted, the ACT request may be transferred from another terminal device 20 to the active terminal device 20. In addition, in a case where a plurality of terminal devices 20 are set active in the group, the usage right may be requested from the plurality of terminal devices 20 by broadcasting the ACT request. Incidentally, when a plurality of terminal devices 20 are set active and a terminal device 20 having received the request for the usage right transfers the right, the terminal device 20 may notify the other active terminal devices 20 of the transfer of the right. Then, the other active terminal devices 20 continue retaining the usage right.

Description has been made of a case where there is a request to withdraw from a group from a terminal device 20 as an example of processing when the terminal device 20 withdraws from the group. However, a terminal device 20 that has ceased communication with any of terminal devices 20 in the group for a given period or more may be withdrawn from the group. In this case, a device detecting that the communication has been interrupted for a certain period or more performs processing for the withdrawal. Suppose for example that the terminal device 20c has not communicated with any of the devices in the group G1 for a given period or more. When the joining processing unit 52b in the terminal device 20b identifies that communication with the terminal device 20c has not been performed for the given period or more, the joining processing unit 52b deletes information about the terminal device 20c from the group accommodation table 61b and the ACT/SBY information table 63b. Information after the update is thereafter synchronized with the other terminal devices 20. Therefore, when none of the other terminal devices 20 has communicated with the terminal device 20c, and the information notified from the terminal device 20b has spread in the group G1, all of the devices in the group G1 recognize that the terminal device 20c is not included in the group G1. On the other hand, when the terminal device 20c may communicate with a part of the devices such as the terminal device 20x, the terminal device 20b records that the terminal device 20c is included in the group G1 based on a notification from the terminal device 20x.

In the above description, a case where the logical identification information 62 is an IMSI has been described as an example. However, the logical identification information 62 is not limited to an IMSI. In addition, depending on implementations, arbitrary information usable for calling processing from the base station 10, such as a temporary mobile subscriber identity (TMSI), may be used in place of a GUTI.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device included in a plurality of terminal devices, the terminal device comprising:
a memory; and
a processor coupled to the memory and the processor configured to:
obtain first identification information used in a group including the plurality of terminal devices and state information, the first identification information being used for device identification in communication between a base station and each of the plurality of terminal devices, the first identification information being allocated to any one of the plurality of terminal devices at a certain timing, the state information indicating whether the first identification information is allocated to the terminal device or not;
when it is determined that the first identification information is not allocated to the terminal device based on the state information, request a usage right of the first identification information for the plurality of terminal devices in response to obtaining data to be transmitted to the base station; and
transmit the data to the base station using the first identification information after obtaining the usage right.

2. The terminal device according to claim 1, wherein
the memory stores a threshold value related to traffic between the group and the base station and an upper limit value of a number of devices that is able to include in the group; wherein
the processor is configured to:
when a request to join the group is received from an additional terminal device, cause the additional terminal device to join the group in a case where a sum of traffic between each of the plurality of terminal devices and the base station does not exceed the threshold value and a value adding one to a number of the plurality of terminal devices does not exceed the upper limit value; and
transmit a message notifying whether or not the additional terminal device joins the group to the additional terminal device.

3. The terminal device according to claim 1, wherein
the processor is configured to:
establish coupling using the first identification information for position registration in communication via the base station;
when the terminal device receives a request for the usage right from a specified terminal device included in the group, ending the coupling such that communication using the first identification information between the specified terminal device and the base station is enabled; and
transmit a notification of transfer of the usage right to the specified terminal device.

4. The terminal device according to claim 1, wherein
the processor is configured to:
obtain a second identification information used for calling processing from the base station, by establishing coupling using the first identification information for position registration in communication via the base station; and
when the terminal device receives a request for the usage right from a specified terminal device included in the group, transfer the usage right to the specified terminal device; and
cause the specified terminal device to perform communication using the first identification information and the second identification information, by notifying the second identification information.

5. A communication method executed by a terminal device included in a plurality of terminal devices, the communication method comprising:
obtain first identification information used in a group including the plurality of terminal devices and state information, the first identification information being used for device identification in communication between a base station and each of the plurality of terminal devices, the first identification information being allocated to any one of the plurality of terminal devices at a certain timing, the state information indicating whether the first identification information is allocated to the terminal device or not;
when it is determined that the first identification information is not allocated to the terminal device based on the state information, requesting a usage right of the first identification information for the plurality of terminal devices in response to obtaining data to be transmitted to the base station; and
transmitting the data to the base station using the first identification information after obtaining the usage right.
